(19) United States
(12) Patent Application Publication
(10) Pub. No.: US 2012/0327929 A1
(43) Pub. Date: Dec. 27, 2012

(54) Connection Switching Device and Telephone Device

(76) Inventors: Chen-Chao Chang, Hsinchu (TW); Jung-Cheng Lee, Hsinchu (TW); Yee-Lee Shyong, Hsinchu (TW)

(21) Appl. No.: 13/236,665

(22) Filed: Sep. 20, 2011

(30) Foreign Application Priority Data
Jun. 24, 2011 (TW) 100211584

(51) Int. Cl. H04L 12/66

(52) U.S. Cl. 370/352

(57) ABSTRACT

A connection switching device for a telephone device supporting a PSTN function and a VoIP function and taking the PSTN function as a default voice communication function is disclosed. The connection switching device includes a dual tone multi-frequency (DTMF) receiver for determining whether a phone number inputted to the telephone device includes a specified trigger code, and a control unit coupled to the DTMF receiver for switching the default voice communication function from the PSTN function to the VoIP function when a decision result of the DTMF receiver indicates that the phone number includes the specified trigger code.

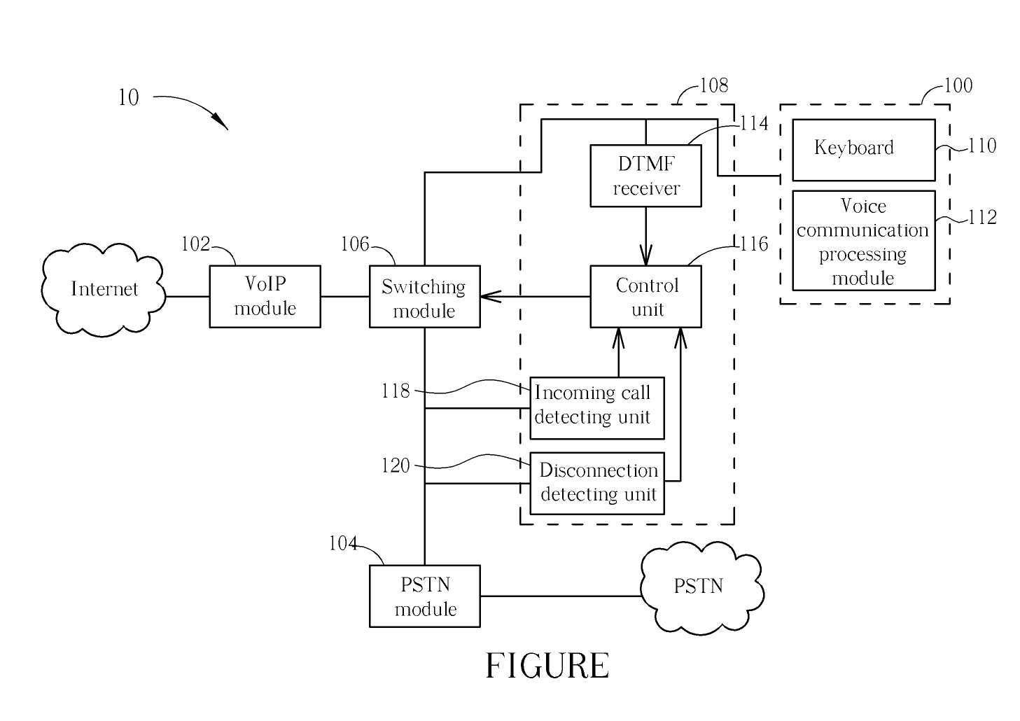

### BACKGROUND OF THE INVENTION

1. Field of the Invention

The present invention relates to a connection switching device and telephone device, and more particularly, to a connection switching device and telephone device predefined to execute PSTN function.

2. Description of the Prior Art

With the continuous development of network communication technology and the popularization of network linking, interpersonal communication is more and more convenient. In the past, only through a public switched telephone network (PSTN) could a real-time voice communication be realized, but now, the technology of voice over Internet protocol (VoIP), makes real -time voice communication through the Internet possible. VoIP technology provides not only high-quality voice communication, but also exchanges of real-time images, data, etc. because the Internet has a larger bandwidth than the PSTN. Moreover, charges for Internet communication, especially for long-distance or international calls, are much cheaper than those for PSTN communication.

Hence, communications via the Internet provides high-quality services of exchanging voices, images, etc., and more importantly, the low charges and high popularization rates of Internet communication can save costs of communication for industries or individuals. However, since a VoIP system is established under Internet protocol, most web phones are realized through software in a computer. That is, a user must use the web phone through the computer, which is much different from typical dialing. Besides, before using the web phone for calling a destination, the user must make sure that the destination is also a web phone, which is again inconvenient.

Therefore, the prior art has developed a dual-function telephone device supporting both a PSTN function and a VoIP function. However, the dual-function telephone device is preset to dial through the VoIP function, and when a user intends to use the PSTN function to dial, the user has to press a specified code, such as “*”, “#”, etc., and then dial the required phone number. In such a situation, when there is an emergency and the user needs to dial numbers such as “911”, the user may not correctly dial the number due to urgency.

In addition, the VoIP function is established on the Internet, and needs continuous power supply to operate, while the PSTN function is powered via telephone lines. In such a situation, since the traditional dual-function telephone device is preset to execute the VoIP function, when a power cut occurs, the traditional dual-function telephone device cannot execute the VoIP function and the PSTN function.

As can be seen, the prior art dual-function telephone device has many disadvantages and needs to be improved properly.

### SUMMARY OF THE INVENTION

It is therefore an object to provide a connection switching device and telephone device.

A connection switching device for a telephone device supporting a PSTN function and a VoIP function and taking the PSTN function as a default voice communication function includes a dual tone multi-frequency (DTMF) receiver, for determining whether a phone number inputted to the telephone device comprises a specified trigger code and a control unit, coupled to the DTMF receiver, for switching the default voice communication function from the PSTN function to the VoIP function when a decision result of the DTMF receiver indicates that the phone number inputted to the telephone device comprises the specified trigger code.

A telephone device includes a keyboard, a voice communication processing module, a VoIP module, coupled to an internet, for executing a VoIP function a PSTN module, coupled to a PSTN, for executing a PSTN function, a switching module, coupled between the voice communication processing module, the VoIP module and the PSTN module, for switching a connection between the voice communication processing module and the VoIP module, or between the voice communication processing module and the PSTN module; and a connection switching device including a DTMF receiver, for determining whether a phone number inputted to the keyboard comprises a specified trigger code, and a control unit, coupled to the DTMF receiver, for controlling the switching module to establish the connection between the voice communication processing module and the PSTN module, and controlling the switching module to connect the voice communication processing module and the VoIP module when a decision result of the DTMF receiver indicates the phone number inputted to the keyboard comprises the specified trigger code.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The FIGURE is a function block diagram of a telephone device according to an embodiment of the present invention.

### DETAILED DESCRIPTION

Please refer to the FIGURE, which is a functional block diagram of a telephone device 10 according to an embodiment of the present invention. The telephone device 10 supports the PSTN function and the VoIP function, and includes a phone 100, a VoIP module 102, a PSTN module 104, a switching module 106 and a connection switching device 108. The phone 100 includes a keyboard 110 and a voice communication processing module 112, the keyboard 110 receives a phone number inputted by a user, and the voice communication processing module 112 processes voice communication. The VoIP module 102 is coupled to the Internet, for executing the VoIP function. The PSTN module 104 is coupled to the PSTN and used for executing the PSTN function. The switching module 106 is disposed among the phone 100, the VoIP module 102 and the PSTN module 104, and is controlled by the connection switching device 108, for switching the voice communication processing module 112 to connect with and the VoIP module 102 or the PSTN module 104. In a default situation, the switching module 106 keeps the connection between the voice communication processing module 112 and the PSTN module 104. In detail, the connection switching device 108 includes a dual tone multi-frequency (DTMF) receiver 114, a control unit 116, an incoming call detecting unit 118 and a disconnection detecting unit 120. The DTMF receiver 114 connects the phone 100 and the switching module 106, and determines whether the phone number inputted by the user through the keyboard 110 includes a specified trigger code. When a decision result of the DTMF receiver 114 indicates the phone number inputted by the user includes the specified trigger code, the control unit 116 controls the switching module 106 to connect the voice communication processing module 110 to the VoIP module 102.

In short, the default voice communication function of the telephone device 10 is the PSTN function. When the user inputs a phone number including the specified trigger code, e.g. “*”, “#” etc., the telephone device 10 changes the default voice communication function to the VoIP function. In such a situation, when there is an emergency that the user has to dial “911” through the telephone device 10, the user can immediately dial correct phone number without pondering on the specified code as in the prior art. In addition, in the telephone device 10, since the switching module 106 connects the voice communication processing module 112 with the PSTN module 104 in default, if the switching module 106 is realized by a circuitry switch, the switching module 106 can keep normal connection between the voice communication processing module 112 and the PSTN module 104 even without power supply. In other words, even if a power cut occurs, the telephone device 10 performs the PSTN function normally, rather than completely shuts down as in the prior art.

Besides, in the telephone device 10, the incoming call detecting unit 118 is utilized for detecting whether there is a PSTN incoming call, and the control unit 116 outputs related messages of the incoming call to the user accordingly. For example, when the user is performing the web phone, if the PSTN incoming call shows up, the control unit 116 sends out an interrupting message, e.g. a flashing light or a ring tone, according to the decision result of the incoming call detecting unit 118, so as to remind the user there is an incoming call. The disconnection detecting unit 120 is utilized for detecting whether a PSTN voice communication of the PSTN module 104 is disconnected, and the control unit 116 adjusts the operation of the switching module 106 accordingly. For example, when the user is performing the PSTN voice communication, if an incoming call of the web phone shows up, the control unit 116 determines whether the user disconnects the PSTN voice communication according to the decision result of the disconnection detecting unit 120, so as to switch to the web phone voice communication.

Noticeably, the FIGURE is an embodiment of the present invention, and those skilled in the art should make modifications accordingly, which is not limited to this . For example, in the FIGURE, each signal solid line between two elements denotes connections between the elements, and is merely to represent signal path, and may be composed of any number of physical wires in practice. For example, the phone 100 may transmit key-in contents received by the keyboard 110 through a wire, and receive voice data processed by the voice communication processing module 112 through another wire. On the other hand, the VoIP module 102 and the PSTN module 104 represent collections of elements for executing the VoIP function and the PSTN function, respectively. In an embodiment, part of functions of the VoIP module 102 and the PSTN module 104 maybe contained in the phone 100, or realized by multiple units. For example, the VoIP module 102 may include a subscriber line interface circuit (SLIC) and a codec, for performing digital and analog signal conversion. Likewise, the PSTN module 104 may include a foreign exchange office (FXO) device and a foreign exchange station (FXS) device. The FXO device is a telephone analog extension line, which simulates a private automatic branch exchange (PABX), to perform transmission of analog signals and telephone ring tones; and the FXS device provides power, transmits dialing voice and generates ring tone voltage.

In the prior art, the telephone device supporting the VoIP function and the PSTN function is preset to execute the VoIP function, which may cause incorrect dialing, or failure in the VoIP function and PSTN function when power cut occurs. In comparison, the telephone device 10 of the present invention is preset to execute the PSTN function through the connection switching device 108. Only when the phone number inputted by the user includes the specified trigger code, the connection switching device 108 switches the voice communication function to the VoIP function. As a result, when there is an emergency, the user can dial the correct phone number immediately. Meanwhile, when power cut occurs, the telephone device 10 still executes the PSTN function normally, to keep the voice communication function.

To sum up, the telephone device of the present invention execute the PSTN function in default, to ensure the user dials correctly, and maintain partial communication functions when power cut, and thus increase convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connection switching device for a telephone device supporting a public switched telephone network (PSTN) function and a Voice over Internet Protocol (VoIP) function and taking the PSTN function as a default voice communication function, the connection switching device comprising:
a dual tone multi-frequency (DTMF) receiver, for determining whether a phone number inputted to the telephone device comprises a specified trigger code; and
a control unit, coupled to the DTMF receiver, for switching the default voice communication function from the PSTN function to the VoIP function when a decision result of the DTMF receiver indicates that the phone number inputted to the telephone device comprises the specified trigger code.

2. The connection switching device of claim 1, further comprising an incoming call detecting unit, for detecting whether there is a PSTN incoming call, wherein the control unit is further utilized for outputting a message related to the PSTN incoming call when a detection result of the incoming call detecting unit indicates there is the PSTN incoming call.

3. The connection switching device of claim 1, further comprising a disconnection detecting unit, for detecting whether a PSTN voice communication is disconnected, wherein the control unit is further utilized for adjusting an operation of the default voice communication function when a detection result of the disconnection detecting unit indicates the PSTN voice communication is disconnected.

4. A telephone device, comprising:
a keyboard;
a voice communication processing module;
a Voice over Internet Protocol (VoIP) module, coupled to an internet, for executing a VoIP function;
a public switched telephone network (PSTN) module, coupled to a PSTN, for executing a PSTN function;
a switching module, coupled to the voice communication processing module, the VoIP module and the PSTN module, for switching the voice communication processing module to connect with the VoIP module or the PSTN module; and
a connection switching device, comprising:
a dual tone multi-frequency (DTMF) receiver, for determining whether a phone number inputted to the keyboard comprises a specified trigger code; and
a control unit, coupled to the DTMF receiver, for controlling the switching module to establish a connection between the voice communication processing module and the PSTN module, and controlling the switching module to connect the voice communication processing module and the VoIP module when a decision result of the DTMF receiver indicates the phone number inputted to the keyboard comprises the specified trigger code.

5. The telephone device of claim 4, wherein the connection switching device further comprises an incoming call detecting unit, for detecting whether the PSTN module receives a PSTN incoming call, and the control unit is further utilized for outputting a message related to the PSTN incoming call when a detection result of the incoming call detecting unit indicates there is the PSTN incoming call.

6. The telephone device of claim 4, wherein the connection switching device further comprises a disconnection detecting unit, for detecting whether a PSTN voice communication is disconnected, and the control unit is further utilized for adjusting an operation of the default voice communication function when a detection result of the disconnection detecting unit indicates the PSTN voice communication is disconnected.
